(19) United States
(12) Patent Application Publication
(10) Pub. No.: US 2007/0046438 A1
(43) Pub. Date: Mar. 1, 2007

(54) Electronic Radio Frequency Identification Transceiver Device Activated by Radiant Means

(76) Inventors: Mark Pempsell, Bedford, TX (US); Ryan Corley, Austin, TX (US)

Correspondence Address: BAKER BOTTS L.L.P., 2001 ROSS AVENUE, SUITE 600, DALLAS, TX, 75201-2980, US

(21) Appl. No.: 11/466,346

(22) Filed: Aug. 22, 2006

Related U.S. Application Data
(60) Provisional application No. 60/712,719, filed on Aug. 29, 2005.

(51) Int. Cl. H04Q 5/22

(52) U.S. Cl. 340/10.34; 340/10.5; 340/572.1; 340/572.3

(57) ABSTRACT

In accordance with the teachings of the present invention, an electronic radio frequency identification transceiver device activated by radiant means is provided. In a particular embodiment an electronic frequency transmitter includes an electronic frequency transmitter with capability to adjust frequency carrier, an electronic frequency transmitter capable of transmitting programmed data bits or bytes, an electronic frequency transmitter capable of receiving data bits or bytes of programmable information, a receiving coil to convert electro-magnetic or radio frequency radiant to electrical current, a transmitter antenna, a receiving antenna, and a programmable input port.

### RELATED APPLICATION

This application claims the benefit of U.S. Provisional Application Ser. No. 60/712,719 filed Aug. 29, 2005.

### TECHNICAL FIELD OF THE INVENTION

The present invention relates generally to article surveillance systems and in particular to a radio frequency identification device that integrally incorporates an electronic article surveillance system.

### BACKGROUND OF THE INVENTION

The problem of protection of merchandise and the like against theft from retail stores has been the subject of numerous technical solutions. Among these, a tag or marker is secured to an article and/or its packaging to be protected. The tag responds to an interrogation signal from a transmitting apparatus either at the exit door of the premises to be protected, or at the aisle way adjacent to the cashier or check out station or by a hand held transmitter receiver. In one case a receiving coil on the opposite side of the exit or aisle way from the transmitting apparatus receives a signal produced by the tag in response to the interrogation signal. The presence of the response signal indicates the tag has not been removed or deactivated by the employee, and that the article bearing it may have not been paid for or properly checked out of the traceable system.

There is a rising use of the radio frequency identification (“RFID”) devices due in part to the retail outlets requiring their suppliers to provide such devices. When such a device is required by the supplier this is known as “source tagging.” By receiving inventory that has been integrally incorporated with the RFID tag it thus allows a retailer to precisely track from point of origin, their inventory from the receiving dock, to the display area, completely through to the point of sale or BAS interrogation gates.

Radio frequency identification devices or RFID tagging exists in numerous systems for the tracking of inventory, identification, raw materials and materials in manufacturing, or other items in a variety of locations, such as manufacturing. distribution and transportation facilities and the like. Accurate and inexpensive locating, tracking, and inventorying of the physical location of items such as parts, goods, and materials is necessary for many operations, such as manufacturing and warehousing for a number of reasons. One such application includes the desire to quickly determine the physical location of a part in the manufacturing process or to determine if a part is present in inventory or storage to determine quantity of an item on hand, tracking the progress of an item in manufacturing, proof of item authenticity and many other functions.

Several different types of RFID tags having been disclosed in literature, and are in use. In one type, the apparatus is a passive RFID tag material tracking system capable of real-time location and identification of thousands of items in production and storage areas. Passive RFID tags are tracked by remote sensing antennas placed in locations to be monitored or scanning interrogators with several multiplexed antenna inputs are attached to sensing antennas and a computer which in turn communicates with interrogators thereby determining exact item location and quantity.

A second type of RFID tagging comes in the form of an external activation or source active. The above mentioned devices are in an active state of data streaming transmission. In the active RFID scheme, the identifying device containing encoded information is placed on or in the goods or other items to be identified by an RFID reader. The encoded information is read by the reader with no user data entry generally required. The information encoded on the RFID tag is then typically passed to a processing medium for decoding. The content of the encoding consists of, but is not limited to, data bits of information of manufacturing tractability, inventory control, purchase price and in some cases the date of manufacturing or purchasing.

Electronic article security systems and in particular the use of the RFID tag discussed above has been shown to be very effective in inventory control and unauthorized removal of articles, particularly at the point of sale.

### SUMMARY OF THE INVENTION

The present invention relates to the means of activation and transmitting of a radio frequency identification device. This invention utilizes the latest in micro-electronic technology readily available to those skilled in the art to practice the invention. Therefore, the present invention is specifically designed to be externally energized by means of an electromagnetic pulse or electromagnetic radiation and such. When the radio frequency identification device is introduced in proximity to such a signal, the device will produce sufficient current to activate the micro electronic circuitry, thereby activating said circuit to begin to transmission of the assigned data stream.

This invention utilizes three major components which when combined may be made without departing from the spirit or scope of the invention, but not limited to its entirety. The first of three is a receiving antenna used to gather energy From an external source generated by means of a radio frequency identification reading device or can in its present form gather supply current by means of internal power Source. This antenna when energized externally, will gather transmitted energy thereby converting said energy in a form suitable to power a micro-electronic circuit. The second article of the invention consists of an electronic micro transmitter adjustable to the frequencies and bit rate as specified by the Consumer Product Manufacturers Association, manufacturers, original equipment manufacturers, distributors, retailers, end users and the like. The third component of the present invention is an antenna sufficient to transmit the data bits produced by the micro-electronic RFID transmitter circuit.

The procedure of utilizing a receiving antenna for product activation along with a transceiver antenna for receiving data bits controlled by a micro-electronic circuit will provide a unique and inconspicuous means of item identification and tracking thereby increasing inventory control and reducing theft and counterfeiting from manufacturing to inventory and retail point of sale.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates an RFID transmitter tag in accordance with a particular embodiment of the present invention;

FIG. 2 illustrates an interrogation gate in accordance with a particular embodiment of the present invention; and

FIG. 3 illustrates an RFID Transceiver in accordance with a particular embodiment of the present invention.

### DETAILED DESCRIPTION OF THE INVENTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, electrical and structural changes may be made without departing From the spirit or scope of the invention. To avoid detail not necessary to enable those skilled in the art to practice the invention, the description may omit certain information known to those skilled in the art. The following detailed description is, therefore, not to be taken in a limited sense and the scope of the present invention is defined only by the appended claims.

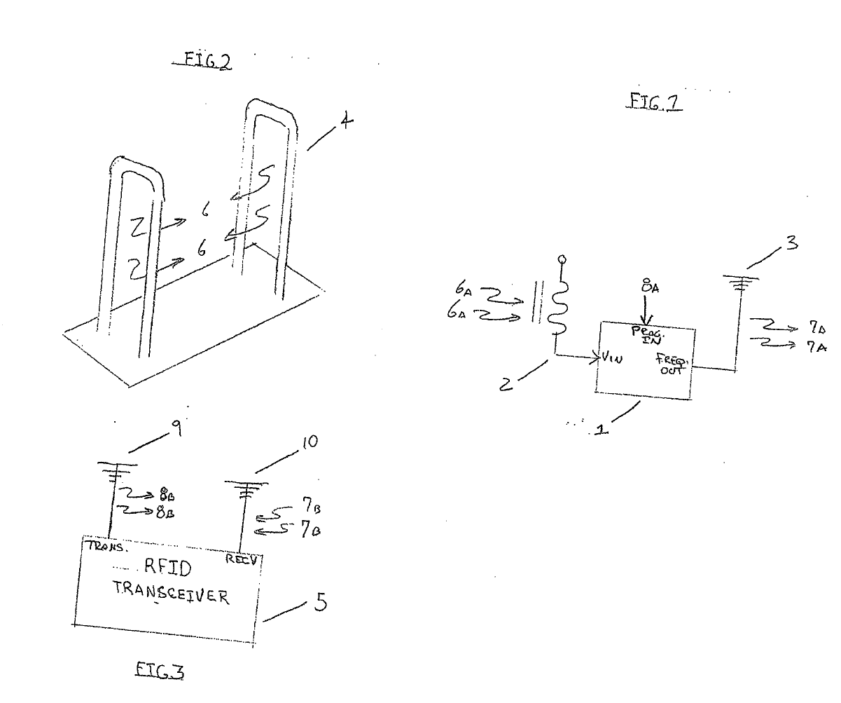

Referring to FIGS. 1, 2 and 3, wherein the same reference numeral designations are applied to corresponding components or functionality throughout the figures, a programmable micro-electronic radio frequency identification transmitter tag according to the present invention is illustrated. An RFID transmitter tag 1 in FIG. 1, consists of a receiving coil 2 which when introduced to the proximity of an interrogation gate 4 in FIG. 2 or an RFID Transceiver 5 in FIG. 3 will energize the coil 2 thus supplying ample electricity to power the RFID transmitter tag 1. The RFID transmitter tag 1 is capable in its present form to receive data bits of information 8b transmitted by an RFID Transceiver 5 by transmitter means 9 which then will be received by RFID transmitter tag 1 through input program port 8a. At the point that RFID transmitter 1 has received the data bit 8b program and the RFID transmitter tag 1 has been sufficiently energized through external sources 6a to antenna 2, the RFID transmitter tag 1 will begin retransmitting data bit 8b through output antenna 3 with signal 7a. When in this state, RFID Transceiver 5 will receive transmission signal 7a through receiving antenna 10 hereby known as received data bit transmission 7b. RFID Transceiver 5 will decode transmission 7b and distribute this information in a form programmed to its specific specification.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. An electronic frequency transmitter comprising:
an electronic frequency transmitter with capability to adjust frequency carrier;
an electronic frequency transmitter capable of transmitting programmed data bits or bytes;
an electronic frequency transmitter capable of receiving data bits or bytes of programmable information;
a receiving coil to convert electro-magnetic or radio frequency radiant to electrical current;
a transmitter antenna;
a receiving antenna; and
a programmable input port.
